(19) United States
(12) Patent Application Publication
(10) Pub. No.: US 2006/0286246 A1
(43) Pub. Date: Dec. 21, 2006

(54) Preparation of bakery mixes

(75) Inventors: Andrew McPherson, Mt. Prospect, IL (US); Manoj Shah, Lindenhurst, IL (US); Kristin G. Neale, Milwaukee, WI (US)

Correspondence Address: FITCH EVEN TABIN & FLANNERY, 120 S. LASALLE STREET, SUITE 1600, CHICAGO, IL, 60603-3406, US

(73) Assignee: Kraft Foods Holdings, Inc.

(21) Appl. No.: 11/153,548

(22) Filed: Jun. 16, 2005

(51) Int. Cl. A21D 10/00

(52) U.S. Cl. 426/555

(57) ABSTRACT

A process for preparing shelf-stable granular bakery mixes from combinations of edible dry ingredients and edible liquid and/or plastic ingredients.

### FIELD OF THE INVENTION

The invention generally relates to preparation of bakery mixes, and particularly shelf-stable granular bakery mixes prepared from combinations of edible dry ingredients and edible liquid and/or plastic ingredients.

### BACKGROUND OF THE INVENTION

Dry bakery mixes for baked goods, such as cakes, breads, pizza crusts and doughnuts, etc., are widely used. They often include, e.g., mixtures of flour components, sweeteners, leavening agents, flavorants, and/or milk solids. These ingredients are combined by conventional dry blending operations. Alternately for bakery mix preparation, mechanical mixing typically has been used to homogeneously incorporate fat sources into the dry bakery mixes. For instance, hammer milling or ribbon blending has been used to incorporate hard or plastic fats, such as shortening, into dry bakery mixes. A batter or dough typically is prepared with the dry bakery mix by addition of one or more of an aqueous source, such as water or milk; a fat source such as a vegetable oil or a plastic fat such as shortening, butter and/or margarine; and/or a liquid protein source, such as liquid egg. The resulting batter or dough is then cooked to form a finished good such as by baking, frying, microwave heating, etc.

The liquid or plastic fat sources generally have not been premixed with the dry bake mix ingredients prior to any packaging and shelf-storage of the bakery mixes. Liquid egg products may have been dried into a powder form by spray drying techniques. However, spray drying of the liquid egg products is relatively expensive.

Arrangements would be desirable for forming dry bakery mixes which can efficiently incorporate liquid and/or plastic fat sources into the dry mixes in a shelf-stable, food grade, functional form. It also would be desirable to provide dry bakery mixes which incorporate dried egg in a convenient and economical manner. The invention addresses the above and other needs in an efficient and economically feasible manner.

### SUMMARY OF THE INVENTION

This invention provides a process for preparing a shelf-stable granular bakery mixes from combinations of edible dry ingredients and edible liquid and/or plastic ingredients in a single unit operation. This invention includes both partial bakery mixes, defined as those in which the end user must add one or more formula components before use, and complete mixes, where the end user must only add water prior to baking.

In some embodiments, a granular bakery mix is prepared from vortex grinding edible food material comprising a farinaceous material, at least one dry particulated baking component different than the farinaceous material, and an edible liquid and/or plastic ingredient selected from the group consisting of a liquid lipid source, a plastic lipid source, liquid eggs, or any combination thereof, in a vortex apparatus as part of a short-duration treatment that substantially preserves desirable functional aspects of the various ingredients which are useful for further food manufacture. The process permits simultaneous grinding and homogeneous mixing of the combined dry and liquid/plastic feed components. Moreover, intimate concurrent mixing and disintegrating of the ingredients having different physical forms is effected inside the vortex apparatus without the need to contact the ingredients with any moving mechanical parts. The granular product obtained is a freely-flowable, particulated material which can be conveniently handled and stored in a stable manner until used in dough-making or other food preparation. Throughout this specification the terms “vortex mixing,” “vortex grinding,” “cyclonic mixing,” and “cyclonic grinding” are used interchangeably.

In some embodiments, a single-stage vortex grinding process is conducted in which compressed air and bakery mix ingredients including edible dry and liquid/plastic components are separately introduced into an enclosure that includes a truncated conical shaped section. After introduction, the compressed air travels generally along a downward path through the enclosure until it reaches a lower end thereof. The air flows back up from the lower end of the enclosure in a central region thereof until exiting the enclosure via an exhaust duct. The bakery mix ingredients are separately introduced into an upper end of the enclosure, and the feed materials become entrained in the air traveling downward through the enclosure until reaching the lower end of the enclosure. During this movement of the feed materials from the upper end of the enclosure down to the lower end thereof, they are at least physically processed. They also may be further dehydrated by use of heated compressed air in which they are suspended in the dynamic air flow system generated within the enclosure. During the same unit operation, larger feed particles, such as whole grain constituents in particular but not exclusively, are disintegrated into small particles and intermixed with the different feed materials present in an extremely short period of time. As such, this attrition and blending of feed components into granular form may be achieved without using a grinding device with moving mechanical parts.

In one embodiment, the edible feed material includes a farinaceous material ingredient comprising whole grain constituent, grain flour, or a combination thereof. The liquid and/or plastic ingredient may comprise a liquid fat such as vegetable oil, and/or a plastic fat such as shortening, butter, margarine, and any combination thereof. The dry particulated baking component may comprise sweetener, leavening agent, flavorant, and other typical bakery mix ingredients, and any combination thereof. The liquid and/or plastic ingredient also may comprise liquid milk products and liquid egg, such as liquid whole egg, liquid egg yolk, liquid egg albumen, or liquid egg blends. In one embodiment, the granular product for cake-type products is prepared by formulating the feed materials introduced into the vortex apparatus to comprise about 15 wt. % to about 90 wt. % about whole grain (flour source), about 1 wt. % to about 45 wt. % sweetener, about 0.25 wt. % to about 35 wt. % shortening, about 0.5 wt. % to about 25 wt. % milk solids, about 0.5 wt % to about 2.0 wt. % leavening, and optionally may further include about 1 wt. % to about 45 wt % liquid egg product(s), with the proviso that at least one of the shortening and the liquid egg products are introduced in a positive amount. In a particular embodiment, cake-type product premixes are prepared by formulating the feed materials introduced into the vortex apparatus to comprise about 15 wt. % to about 30 wt. % about whole grain (flour source), about 20 wt. % to about 45 wt. % sweetener, about 3 wt. % to about 20 wt. % shortening, about 3 wt. % to about 25 wt. % milk solids about 0.5 wt % to about 2.0 wt. % leavening, and about 4 wt. % to about 45 wt % liquid egg product(s). As can be appreciated, bulk moisture content of the various materials fed into the cyclonic unit generally will be volatized during processing while the original solids content remains essentially intact on a mass basis, making it possible to formulate a granular product with reference to the original feed materials. In an alternative embodiment, a portion or all of the whole grain ingredient may be replaced by a preground flour form thereof. It is appreciated that in certain specialty cakes, such as angelfood types, lipid and fat sources are not ordinarily used in the formulas. In these types of formulations the lipid contribution is 0 wt. %, and the balance of components may be present in the respective above-indicated amounts. In one embodiment, the granular product obtained has a total moisture content of less than 14 wt. %.

The granular products of the embodiments herein may be used as bakery mixes, bases, concentrates and the like. They may be used in the preparation of baked goods, such as, but not limited to, bread-type products (e.g., breads, rolls, muffins, biscuits, and bagels), pizza crusts, sweet goods, laminated sweet goods, pastries, danish, doughnuts, cakes, cookies, crackers, waffles and the like. It may be desirable to modify existing dough or batter formulations and processes in order to optimize the use of the granular products of this invention, but this can be done on a product-by-product basis, as desired, by skilled bakers.

Preparation of bakery mixes in accordance with embodiments of this invention offers numerous advantages over conventional schemes for preparing them. For instance, separate storage and handling of liquid/plastic lipid sources and/or liquid eggs until dough-making is not necessary as those components can be stably incorporated directly into the dry or granular bakery mix itself in advance using processing in accordance with embodiments herein. Also, liquid egg can be incorporated into the bakery mix during the vortex processing of embodiments herein. It is converted in-situ into a dried egg form that also is homogeneously blended throughout the other ingredients in the resulting granular product discharged from the vortex process apparatus. The vortex grinding/mixing treatment preferably may be achieved as a single-stage operation without impairing the desirable functional attributes of the food material, and without requiring different processes be performed in different equipment. Additionally, the process can be operated in a continuous mode as the compressed air is continuously exhausted from the system after entraining the food downward through the enclosure to its lower end, and ground food product material can be withdrawn from the lower end of the enclosure. Relatively little if any food residue is left on the inner walls of the processing unit, making it easy to clean and facilitating switching to a different type of processed food for processing within the unit. These advantages reduce process complexity, production time, and production and service costs.

### BRIEF DESCRIPTION OF THE DRAWINGS

Other features and advantages of the invention will become apparent from the following detailed description of preferred embodiments of the invention with reference to the drawings, in which:

FIG. 1 is a flow chart of a method for making granular bakery mixes according to an embodiment of this invention.

FIG. 2 is a schematic view of a system useful for making granular bakery mixes according to an embodiment of this invention.

FIG. 3 is a cross sectional view of the cyclone unit used in the processing system illustrated in FIG. 2.

FIG. 4 is a schematic view of a system useful for making granular bakery mixes according to another embodiment of this invention.

The features depicted in the figures are not necessarily drawn to scale. Similarly numbered elements in different figures represent similar components unless indicated otherwise.

### DETAILED DESCRIPTION OF THE PREFERRED EMBODIMENTS

Preferred embodiments of the invention will be described below with specific reference to unique processing for preparation of bakery mixes. Cyclonic milling is accomplished by the action of compressed air rotating materials in a cyclonic fashion, resulting in the disintegration of bakery mix ingredients into very small particle size in a short period of time. The grinding process is implemented on a cyclonic type system that may be operated in a manner whereby dry and liquid/plastic feed ingredients may be physically acted upon in a beneficial manner in the same process chamber. A ground food product is obtained in a granulated form (e.g., a solid fine particulate) which is suitable for use as a bakery mix and the like. Production of whole-grain flour from whole grain products like corn, oats and ground by-products like rice bran using this technology is also possible. Endogenous oils and antioxidants from the products are homogeneously incorporated with the pulverized particles which may aid in providing a granular product which more stable to lipid oxidation. Appropriate air temperature management controls the vaporization of natural antioxidants. Additionally, liquid streams such as egg products and/or lipids are introduced, such as by injection, pouring, etc., into a vortex processing chamber described herein. When eggs and/or oil are combined with mixture of flour, sweeteners, leavening agents and flavorants in the cyclonic milling chamber the resultant product is a bakery mix with homogeneously dispersed fat and egg at a moisture content appropriate for stability during normal storage. This present invention provides a unique method to produce a bakery mix, base, and concentrate preparation without need to use moving mechanical parts to comminute and blend the ingredients. It also allows for use of liquid egg products which are safely dried during cyclonic milling in a cost-effective manner. The greatly reduced process time for mixing, as compared to conventional mechanical bakery mix blending operations, results in improved efficiency, which reduces cost. A homogeneously dispersed lipid in the mix, base or concentrate also is provided. A better dispersion of added antioxidants also can be provided, which yields improved oxidative stability of the resultant mix, base, or concentrate. The process can be readily and easily varied based on the desired end product attributes, as will be further appreciated from the descriptions that follow.

For purposes herein, “grinding” a particle means crushing, pulverizing, abrading, wearing, or rubbing the particle to break it down into smaller particles and/or liberate smaller particles, and includes mechanisms involving contact between moving particles, and/or between a moving particle and a static surface; and “drying” means dehydrating, i.e., reducing moisture content. The term “dough” as used herein is meant a mixture of flour and other ingredients stiff enough to knead or roll. The term “batter” as used herein consists of flour, liquids such as milk or water and other ingredients and is thin enough to pour or drop from a spoon. The term “bakery mix” or “dry mix” as used herein is meant to include ingredients of a flour-containing mixture capable of being baked in combination with liquids added to form a desired dough or batter. Unless otherwise indicated, “dry” refers to a material containing less than about 14 wt. % total water.

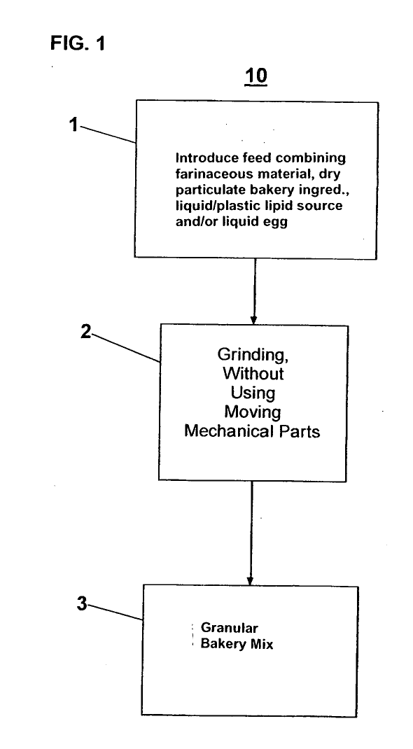

Referring to FIG. 1, in this non-limiting illustrated embodiment edible food material comprising a farinaceous source, other dry particulate ingredients, and the lipid source and/or liquid egg is introduced into a vortex apparatus that is described in more detail infra (step 1), and the edible food material is subjected to a grinding treatment in the vortex apparatus (step 2), providing a dry flowable, granular bakery mix (step 3).

Upon completing step 2, a granular food product is obtained which is suitable for use in preparing baked goods and other food preparations. For instance, the granulated food product obtained substantially retains flavor and/or functional attributes of its various admixed feed components through the grinding treatment. The granular food product may be stably stored until used in subsequent food production while containing dried lipid solids or residues and/or dried egg solids or residues.

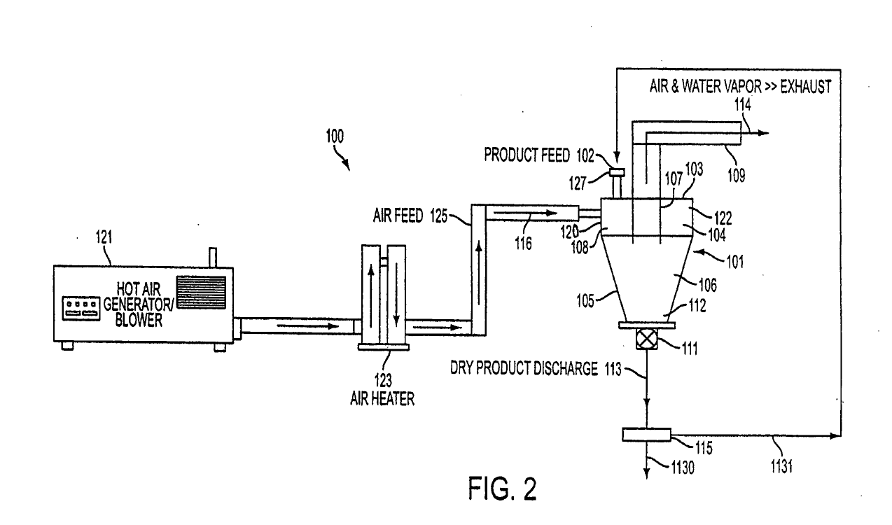

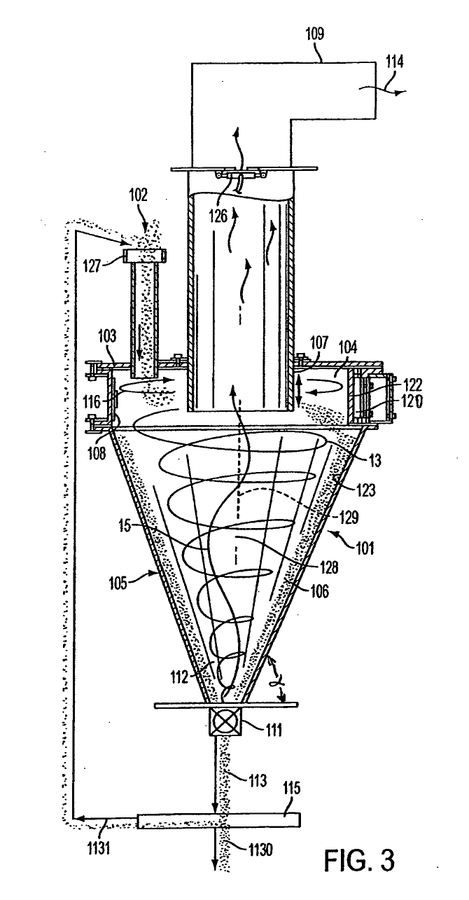

Referring now to FIGS. 2 and 3, details of an exemplary equipment arrangement and process of operating it for conducting the grinding of the bakery mix ingredients in step 2 of FIG. 1 is discussed hereinafter. Referring to FIG. 2, an exemplary system 100 for performing grinding of bakery mix ingredients according to a process embodiment of this invention is shown. Cyclone 101 is a structural enclosure comprised of two fluidly communicating sections: an upper cylindrical enclosure 103 defining a chamber 104; and a lower truncated conical shaped enclosure 105 that defines a cavity 106. Both the upper and lower enclosures are annular structures in which a solid wall or shell encloses an interior space. In this illustration, the upper enclosure 103 has a generally uniform cross-sectional diameter, while the lower enclosure 105 tapers inward towards its lower end 112. In a non-limiting embodiment, the taper angle α of lower enclosure 105 may range from about 66 to about 70 degrees (see FIG. 3). For purposes herein, the terminology “enclosure” means a structure that encloses a chamber, cavity, or space from more than one side.

Compressed air 116 and bakery mix ingredients 102 are separately introduced into the cyclone 101 at the upper enclosure 103. Optionally, an additional liquid addition port (not shown) is provided on or near the top of the upper enclosure 103 which may be used to introduce liquid ingredients such as egg products and lipid sources. The various feed components may be introduced individually, in precombination, or lesser combinations thereof into the cyclone 101. The processed bakery mix ingredients are discharged as a solid particulate 113 from the lower end 112 of the cyclone 101. An optional valve mechanism 111, such as a rotary valve or rotary air-lock, is shown that permits extraction of dried, ground food from the cyclone without interrupting continuous operation of the system and which minimizes leakage of the introduced air from the cyclone 101. Alternatively, a hollow cylindrical extension shaft (not shown), optionally may be installed on the lower end 112 of the cyclone 101 to help direct granulated product into a receptacle or the like situated below the cyclone. In the absence of a valve mechanism at the lower end 112 of the cyclone 101, the pressurized air introduced into the cyclone also will escape from the cyclone 101 via opening 111 at the cyclone's lower end 112. This additional air loss may need to be need to be compensated for in the inlet air feed rate to sustain a desired air pressure condition inside the cyclone, such as by increasing it sufficient to offset air loss occurring from both the bottom of the cyclone as well as the exhaust gas stream 114.

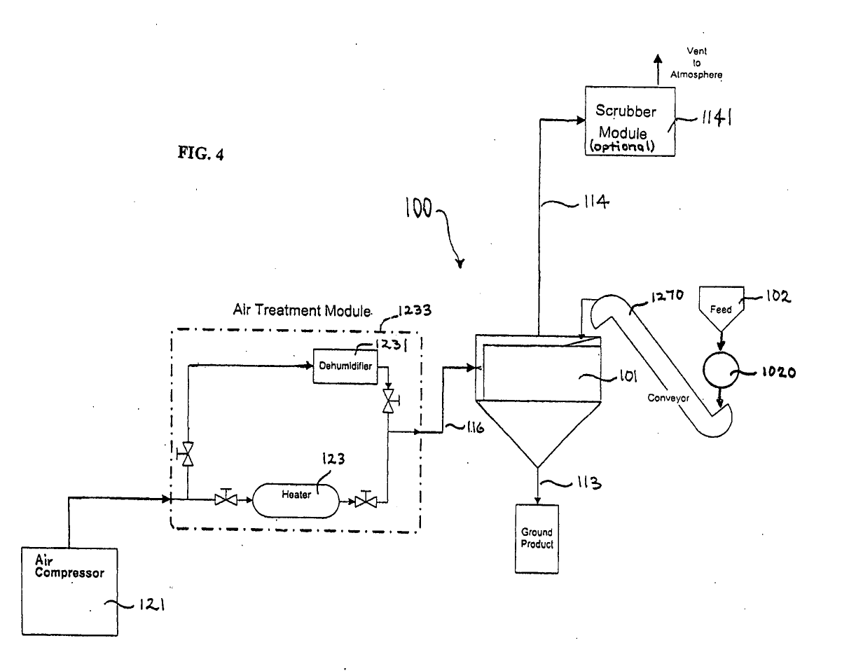

Air, and possibly some small amount of moisture vapor released from the feed material during treatment within the cyclone 101, is exhausted as exhaust gases 114 from the cyclone via sleeve 107 and exhaust duct 109. Some nominal amount of light debris may be liberated from the food during processing in the cyclone, and may be eliminated with the exhaust gas stream 114. The exhaust gas stream 114 optionally may be particle filtered, and/or scrubbed to strip out volatile compounds or other compounds, such as using a separate scrubber module, e.g. a packed bed type scrubber, before it is vented to the atmosphere (e.g., see FIG. 4, feature 1141). Sieving device 115 is described in more detail later herein.

To introduce the compressed air 116 into cyclone 101, an air pressurizing mechanism 121, such as a blower or air compressor, generates a high volume, high velocity compressed air stream that is conducted via air ducting 125 through a heating unit 123, and from there is introduced into upper enclosure 103 of cyclone 101. Heating the compressed air before its introduction into the cyclone 101 is useful for moisture content control or adjustment in the product. The term “compressed air” refers to air compressed to a pressure above atmospheric pressure, e.g., above 14.7 psia (lb./inch² absolute). The term “heated air” refers to air heated to a temperature above ambient temperature, e.g., above 75° F. (24° C.). The term “compressed heat air” refers to air having both these characteristics.

The compressed air 116 is introduced into chamber 104 substantially tangentially to an inner wall 108 of the upper enclosure 103. This can be done, for example, by directing the air stream 116 to a plurality of holes 120 (e.g., 2 to 8 holes) circumferentially spaced around and provided through the wall 108 of the upper enclosure 103 through which the air stream is introduced. Deflection plates 122 can be mounted on inner wall 108 of upper enclosure 103 for deflecting the incoming stream of air into a direction substantially tangential to the inner wall 108 according to an arrangement that has been described, for example, in U.S. patent application publication no. 2002/0027173 A1, which descriptions are incorporated herein by reference. The compressed air may be introduced into the upper enclosure 103 of cyclone 101 in a counter-clockwise or a clockwise direction.

The introduced air 10 generally may be further pressurized cyclonically in the chamber 104 and cavity 106. Due to the centrifugal forces present in the cyclonic environment, it is thought that the pressure nearer the outer extremities of the cavity 106 is substantially greater than atmospheric pressure, while the pressure nearer the central axis of the cavity 106 is less than atmospheric pressure. As shown in FIG. 3, as a non-limiting illustration, after being introduced into upper enclosure 103, the compressed air 116 spirals or otherwise travels generally along a large downward path as a vortex 13 through the upper enclosure 103 and the lower conical shaped enclosure 105 until it reaches a lower end 112 thereof. In this illustration, near the lower end 112 of the cavity 106 defined by the inner walls 123 of lower enclosure 105, the downward direction of the air movement is reversed, and the air (and any moisture vapor released from the food during treatment within the cyclone 101) whirls back upwardly as a smaller vortex 15 generally inside the larger vortex 13. The smaller vortex 15 flows back up from the lower end 112 of the lower enclosure 105 in a central region 128 located proximately near the central axis 129 of the cyclone 101 and generally inside the larger vortex 13. The smaller vortex 15 flows upward until exiting the enclosure via sleeve 107 and then exhaust duct 109.

A vortex breaking means (not shown) optionally can be interposed below or inside the lower end 112 to encourage the transition of the larger vortex 13 to the smaller vortex 15. Various vortex breaking arrangements for cyclones are known, such as the introduction of a box-shaped enclosure at the bottom of the conical enclosure.

The bakery mix ingredients 102 are separately introduced into upper enclosure 103. The introduced bakery mix ingredients drop gravitationally downward into chamber 104 until they become entrained in the vortex 13 within cyclone 101. Preferably, the bakery mix ingredients are introduced into upper enclosure 103 in an orientation such that they will fall into the cyclonic vortex 13 generated within cyclone 101, where located in the space between the sleeve 107, and inner wall 108 of the upper enclosure 103. This feed technique serves to minimize the amount of bakery mix ingredients that may initially fall into extreme inner or outer radial portions of the vortex where the cyclonic forces that the food experiences may be lower. As indicated, the feed material 102 may be preheated before it is introduced into the cyclone 101 by directing the feed material through heater device 123. The entrained food travels in the vortex 13 of air spiraling or otherwise traveling downward through the lower enclosure 105 until reaching the lower end 112 of the lower enclosure 105. During this downward flow path, the grinding effects on the food material may occur at different times respective times and at different places during the downward flow path of the food through the cyclone. While not desiring to be bound to any theory, it is thought that pressure-gradient and coriolis forces across, cavitation explosions, and the collision interaction between the various food particles entrained in the high-velocity cyclonically pressurized air may be violently disruptive to the physical structure of that food material. Alternatively, or in addition thereto, the centrifugal force of the vortex may move the food material forcefully against inner walls 108 and 123 of the enclosure. These modes of attrition, individually or in combination, or other modes of attrition that may occur within the cyclone which may not be fully understood, bring about comminuting (grinding) of the food material concurrent with any drying of it. As a result, during this movement of the food material from the upper enclosure 103 down to the lower end 112 of the lower enclosure 105, the granulated product is physically processed in beneficial ways. The unit 101 does not have and requires no mechanical moving parts for effecting grinding of the feed material.

In a further embodiment of the invention, the discharged solid particulate product 113 can be screened, such as using a sieve, such as a screen sieve or other suitable particulate separation/classifying mechanism 115, to sort and separate the finer fraction of ground food 1130 in the solid particulate product 113 that have particle sizes meeting a size criterion, such as being less than a predetermined size, which are suitable for post-grinding processing, from the coarser product fraction 1131. The coarser (oversize) product fraction 1131 can be redirected into the upper enclosure of the cyclone for additional processing therein. A conveyor (not shown) could be used to mechanically transport the redirected coarser material back to feed introducing means 127 or other introduction means in upper enclosure 103 of cyclone 101. Also, feed introducing means 127 may be an inclined conveyor, screw feeder, etc. (e.g., see FIG. 4, feature 1270), which transports feed material into chamber 104 of the cyclone 101 at the upper enclosure 103. Also, some of the ingredients may be injected into upper enclosure 103 in a flowable condition.

It will be appreciated that sleeve 107 can be controllably moved up and down to different vertical positions within cyclone 101. In general, the lower sleeve 107 is spaced relative to the cavity 106, the smaller the combined total volume of the cyclone 101 which is available for air circulation. Since the volume of air being introduced remains constant, this reduction in volume causes a faster flow of air, causing greater cyclonic effect throughout cavity 106 and consequently causing the food to be ground to circulate longer in the chamber 104 and the cavity 106. Raising the sleeve 107 generally has the opposite effect. For a given feed and operating conditions, the vertical position of sleeve 107 can be adjusted to improve process efficiency and yield.

Also, a damper 126 can be provided on exhaust duct 109 to control the volume of air permitted to escape from the central, low-pressure region of cavity 106 into the ambient atmosphere, which can affect the cyclonic velocities and force gradients within cyclone 101. Other than the optional damper, the unit 101 generally requires no moving parts for operation, and particularly with respect to effecting the grinding action which occurs within the unit. The damper may effect conditions within the unit 101 but is not considered to be associated with grinding the grain or other feed components within the unit.

By continually feeding processed food into cyclone 101, a continuous throughput of ground food product material 113 is obtained. A non-limiting example of a commercial apparatus that can be operated in a continuous manner while processing food according to processes of this invention is a WINDHEXE apparatus, manufactured by Vortex Dehydration Systems, LLC, Hanover Md., U.S.A. Descriptions of that type of apparatus are set forth in U.S. patent application publication no. 2002/0027173 A1, which descriptions are incorporated in their entirety herein by reference.

The cyclonic system 100 can provide very high heat transfer rates from hot air to feed components for any further drying or moisture control that may be optionally desired, and mechanical energy to disintegrate and granulate feed components, as they descend through the cyclone unit 101. The food exiting the cyclone 101 exhibits a flowable solid particulate type form, which may be a flour-like or powdery material.

The processing unit 101 may be left relatively clean and tidy, as feed material does not tend to cling as residue to the interior walls of the process unit used to grind the material into granular form. This can facilitate any desired change-over for processing a different type of feed material within the same unit. In one process scheme for processing bakery mix ingredients, the introduction of the compressed air into the cyclone comprises supplying compressed air at a pressure within the range of from about 10 psig to about 100 psig, particularly from about 20 psig to about 60 psig, and more particularly from about 26 psig to about 40 psig.

The temperature of the air introduced into the cyclone is controlled to ensure sufficient thermal energy is provided to allow a particulated or granular product to be generated by the process. The compressed air may be introduced as unheated ambient temperature air or heated using heater unit 123. The thermal condition of the vortex air or other gas facilitates dehydration of high moisture feed components, e.g., liquid eggs if used. The higher moisture ingredients thus can be converted into flowable solid particulate forms which disperse more thoroughly amongst the other feed components. It also may be used to liquefy or partially liquefy plastic fat ingredients, e.g., shortening, which can aid dispersion of shortening throughout and its coating of and/or other association with dry particulated feed components present within the cyclone 101. In one embodiment the compressed air is introduced into the cyclone at a temperature within the range of about 40° F. to about 600° F., particularly about 50° F. to about 500° F., and more particularly about 70° F. to about 450° F. If the compressed air temperature is too high, the feed components may become heat damaged. Also, at air temperatures below about 120° F., particularly at high ambient relative humidity conditions, the feed components may tend to cake or form pastes inside the cyclone unless the compressed air is also dehumidified before it is introduced into the cyclone. As the air temperature is increased, the air generally has more water holding capacity and wet food caking or pastiness is more easily avoided within the process unit.

The volumetric introduction rate of the compressed air into the cyclone is within the range of from about 500 cubic feet per minute (CFM) to about 10,000 cfm, particularly from about 1,500 CFM to about 3,000 CFM, and more particularly from about 300 cubic feet per minute to about 800 cubic feet per minute.

The overall feed rate of the bakery mix ingredients can vary, but generally may be in the range of about 1 to about 300 pounds per minute, particularly about 50 to about 150 lbs./min, for about a 1 to about 10 foot diameter (maximum) cyclone. The cyclone diameter may be, for example, from about 1 to about 10 feet in diameter, particularly about 1 to about 6 feet in diameter.

The bakery mix ingredients may be processed within the above-noted cyclone arrangement within a very short period of time. In one embodiment, upon introducing the bakery mix ingredients into the cyclone, a granulated product thereof is discharged from the processing unit within about 15 seconds, and particularly within about 1 to about 5 seconds. Volatile components also may be handled by conducting the cyclone exhaust through a scrubber unit and the like after it exits the cyclone unit.

Substantially all the introduced bakery mix ingredients may be discharged as processed product within such a short period of time. The above-noted processing temperatures and durations applied during grinding of the bakery mix ingredients generally are low enough to help prevent any significant undesired changes in the starch structure, or other physico-chemical attributes relevant to food-processing, from occurring during the grinding treatment such as described herein. Any ungelatinized starch content present in the farinaceous material or other feed material component (before granulation) is preserved substantially intact and ungelatinized through the grinding treatment performed in accordance with this invention on the bakery mix ingredients. Conventional milling generally employs moving parts to effect attrition of a material, which tends to generate localized high heat. Intense or unduly elevated temperature may increase the risk of degradation of desirable food functional features.

It may be necessary to dehumidify the compressed air before it is introduced into the cyclone unit in high relative humidity (RH) conditions (e.g. RH greater than about 50%) to ensure that the feed material can be attrited into granular form and does not build-up into a sticky or pasty mass inside the cyclone. The air may be dehumidified using a conventional cooling coil unit or similar device used for dehumidification of process air (e.g., see FIG. 4, feature 1231). The dehumidifier or air dryer 1231 may be a commercial unit for the general purpose, e.g., a Model MDX 1000 air dryer from Motivair, Amherst, N.J.

The heater 123, and the dehumidifier 1231 under certain applicable conditions such as indicated above, that are used in conditioning the compressed air before its introduction into the cyclone 101 in accordance with embodiments of this invention are units of a subsystem represented as air treatment module 1233 in FIG. 4. As indicated in FIG. 4, control valves and the like may be used to selectively control and manage air flow through the various air treatment units in module 1233.

Ground food product obtained by the vortex grinding process of embodiments herein generally has commercially useful particle sizes. In one embodiment, the dried, ground food product obtained by processing bakery mix ingredients according to an embodiment of this invention generally may have an average particle size of less than about 1,000 microns, particularly about 1 micron to about 1,000 microns, and more particularly about 2 to about 1,000 microns. In one embodiment, the solid particulate product obtained as the bottoms of the cyclone comprise at least about 50% ground food product having an average particle size of about 1 micron to about 1,000 microns.

Many benefits and advantages are obtained from practice of embodiments of the present invention. For example, separate storage and handling of liquid/plastic lipid sources and/or liquid eggs until dough-making is not necessary as those components can be stably incorporated directly into the dry bakery mix itself in advance using processing in accordance with embodiments herein. Also, liquid egg can be incorporated into the bakery mix during the vortex processing of embodiments herein. It is converted in-situ into a dried egg form that also is homogeneously blended throughout the other ingredients in the resulting granular product discharged from the vortex process apparatus. The vortex grinding/mixing treatment preferably may be achieved as a single-stage operation without impairing the desirable functional attributes of the food material, and without requiring different processes be performed in different equipment. Additionally, the process can be operated in a continuous mode as the compressed air is continuously exhausted from the system after entraining the food downward through the enclosure to its lower end, and ground food product material can be withdrawn from the lower end of the enclosure. Relatively little if any food residue is left on the inner walls of the processing unit, making it easy to clean and facilitating switching to a different type of processed food for processing within the unit. Also, endogenous oils and antioxidants in edible whole grain feed components can be homogenously incorporated with the pulverized particles. The dispersion of these naturally-occurring antioxidant constituents throughout the granular product may result in a granular product which is more stable to lipid oxidation. Air temperature within the processing unit may be facilely controlled to control vaporization of natural antioxidants present in the edible seeds. Also, air temperature within the processing unit may be facilely controlled to control vaporization of natural antioxidants present in the edible seeds. These advantages reduce process complexity, production time, and production and service costs.

In one embodiment, the edible feed material includes a farinaceous material ingredient comprising whole grain constituent, grain flour, or a combination thereof. The liquid and/or plastic ingredient may comprise a liquid fat such as vegetable oil, and/or a plastic fat such as shortening, butter, margarine, and any combination thereof. The dry particulated baking component may comprise sweetener, leavening agent, flavorant, and other common bakery mix ingredients, and any combination thereof. The liquid and/or plastic ingredient also may comprise liquid egg, such as liquid whole egg, liquid egg yolk, liquid egg albumen, or liquid egg blends. In general, the various feed materials will be introduced approximately simultaneously into the cyclone processing apparatus in respective amounts, on a dry basis, that will correspond to the desired bakery mix composition. Other than loss attributable to water vapor and very small amounts of other volatiles or chaff-like material, the mass of the granular product obtained will approximate the dry weight of the combined feed materials. In one embodiment, the granular product for cake-type products is prepared by formulating the feed materials introduced into the vortex apparatus to comprise about 15 wt. % to about 90 wt. % about whole grain (flour source), about 1 wt. % to about 45 wt. % sweetener, about 0.25 wt. % to about 35 wt. % shortening, about 0.5 wt. % to about 25 wt. % milk solids about 0.5 wt % to about 2.0 wt. % leavening, and optionally may further include about 1 wt. % to about 45 wt % liquid egg product(s), with the proviso that at least one of the shortening and the liquid egg products are introduced in positive amount. In a particular embodiment, cake-type product premixes are prepared by formulating the feed materials introduced into the vortex apparatus to comprise about 15 wt. % to about 30 wt. % about whole grain (flour source), about 20 wt. % to about 45 wt. % sweetener, about 3 wt. % to about 20 wt. % shortening, about 3 wt. % to about 25 wt. % milk solids about 0.5 wt % to about 2.0 wt. % leavening, and about 4 wt. % to about 45 wt % liquid egg product(s). As can be appreciated, bulk moisture content of the various materials fed into the cyclonic unit generally will be volatized during processing while the original solids content remains essentially intact on a mass basis, making it possible to formulate a granular product with reference the solids contents of the various feed materials. It is appreciated that in certain specialty cakes, such as angelfood types, lipid and fat sources are not ordinarily used in the formulas. In these types of formulations the lipid contribution is 0 or essentially 0 wt. %, and the balance of components may be present in the respective above-indicated amounts. In a particular embodiment, a bread mix is prepared from dry ingredients derived from the feed materials introduced into the vortex apparatus comprising about 50 wt. % to about 90 wt. % about whole grain, about 1 wt. % to about 10 wt. % sweetener, about 1 wt. % to about 20 wt. % shortening, about 0.5 wt % to about 3.0 wt % salt, optionally may further include about 1 wt. % to about 15 wt % dry milk powder(s) and minor amounts (less than 0.5 wt %) emulsifier, dough conditioners, and/or mold inhibitors. In an alternative embodiment, a portion or all of the whole grain ingredient may be replaced by a preground flour form thereof. In one embodiment, these various granular products obtained have a total moisture content of less than 14 wt. %.

The farinaceous material may comprise whole grain constituents. The whole grain constituents may include one or more principal parts of whole cereal grain, such as the pericarp or bran (external layer of grain), the endosperm (farinaceous albumen containing starch), and/or the germ (seed embryo). In one embodiment, unmilled whole grain seeds are used as the farinaceous material. Examples of sources of the whole grain constituents include, e.g., wheat, corn, oats, barley, rice, rye, sorghum, milo, rape seed, triticali, and mixtures thereof, as well as various milling materials of such cereal grains, such as bran. The farinaceous material also may comprise meals, flours, starches, or glutens, obtained or derived from whole cereal grain or primary constituents thereof, such as by grinding or milling cereal grains. The farinaceous materials are not limited to the above-indicated cereal grains, meals or flours, but also may comprise tuberous foodstuffs, such as tapioca, dried potatoes, and flours and meals obtained therefrom. These starch-containing materials can be processed without incurring undue gelatinization or other undesirable changes. The grinding unit described herein permits relatively short duration, low temperature processing to be used, which is thought to help inhibit and avoid starch transformations (e.g., gelatinization) during processing. The different types of farinaceous materials may be used singly or in any combinations thereof. Also, other types of grain may included or used in the feed material, such as pulse seeds, e.g., soybeans, kidney beans, navy beans, mung beans, peanuts, peas, or other leguminous plant seeds or processed products thereof (e.g., soybean oil).

The liquid and/or plastic lipid source may include vegetable, animal, and/or synthetic edible fats, oils, or mixtures thereof. Typical vegetable oils in this regard may be selected from the naturally occurring liquid triglyceride oils such as soybean oil, canola or rapeseed oil, cottonseed oil, peanut oil, sesame oil, corn oil, sunflower seed oil, coconut oil, palm oil, palm kernel oil, safflower oil, olive oil, ground nut oil, and combinations thereof. In one embodiment, these oils generally are flowable or fluid-like at approximately room temperature or higher conditions. The plastic fat compositions typically are based on triglyceride mixtures triglyceride oils or hard fats. These plastic lipids are generally-self-supporting, non-flowable semi-solid materials at room temperature. The also melt or become molten and flowable upon exposure to sufficient heating conditions therefore. The plastic or hard stock lipid component may comprise, e.g., shortening, butter, margarine, and the like. Exemplary plastic or hard stocks are prepared from hydrogenated soybean oil, hydrogenated cottonseed oil, and the like, in conventional manners. A liquid shortening system also may be used comprising a mixture of liquid and solid lipids, and typically will comprise a major amount of liquid vegetable oil and a minor amount of plastic or hard fat. Suitable liquid and/or plastic lipid sources are described, for example, in U.S. Pat. No. 5,378,490 (Nabisco), which disclosures are incorporated herein by reference.

The dry particulated baking component may comprise, e.g., one or more of sweetener, leavening agent, flavorant, as well as other common bakery mix ingredients such as dairy solids, nuts or nut flour, emulsifiers, preservatives, fruits, candies, minerals, vitamins, or any combination thereof. The sweetener may comprise sugar, honey, molasses, various corn syrups, and/or artificial sweetening agents. The flavorants may comprise, e.g., seasonings such as salt, and flavoring agents such as vanilla, cocoa, chocolate, mint, and so forth. The bakery mix may also comprise a leavening agent. Suitable leavening agents include yeast, and baking powder such as those containing sodium bicarbonate, tartaric acid, and the combination of one or more baking acids with sodium bicarbonate. The dairy solids may comprise powdered milk, nonfat dairy milk, dairy protein concentrates or isolates, etc. Typical bakery emulsifiers also may be included. Useful as the emulsifier component herein are a wide variety of emulsifiers for dry mixes for prepared foods and the skilled artisan will have no difficulty in selecting particular emulsifiers for particular dry mix and use applications. Generally useful as the emulsifier component are partially esterified polyhydric compounds having surface active properties. Other ingredients which may be optionally added include dough seasonings, extenders, preservatives, and food colorings as desired. Enrichment nutrients also may be optionally added to the feed material, including, e.g., thiamine, riboflavin, niacin, iron, calcium, and mixtures thereof.

The granular food product obtained in accordance with embodiments of this invention is edible and may be used in a wide variety of foodstuffs for a variety of purposes, and particularly is suitable as a bakery mix. The granulated food product has ability to contribute the desired flavor and function without adversely impacting finished food products. The granulated food product obtained generally is shelf stable, and may be used to impart flavor and/or functional properties to a food product, such as a baked good, being manufactured after many months of storage of the granulated food product, such as up to about twelve months storage/shelf life or more. By suitable selection of materials fed in combination into the cyclonic processing unit, the granular food product may be prepared as a partial bakery mix or complete mix. A complete mix can be provided which only needs water added (e.g., liquid water or milk) prior to baking, in order to form a dough or batter, etc. Thus, an “instant” granular mix can be provided in embodiments of the present invention for the added convenience of the end user. The granular products of the embodiments herein may be used as bakery mixes, bases, concentrates and the like. They may be used in the preparation of baked goods, such as, but not limited to, bread-type products (e.g., breads, rolls, muffins, biscuits, and bagels), pizza crusts, sweet goods, laminated sweet goods, pastries, danish, doughnuts, cakes, cookies, crackers, waffles and the like. It may be desirable to modify existing dough or batter formulations and processes in order to optimize the use of the granular products of this invention, but this can be done on a product-by-product basis, as desired, by skilled bakers.

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A process for making a bakery mix, comprising:
introducing, into a vortex grinding apparatus, edible food material comprising a farinaceous material, at least one dry particulated baking component different than the farinaceous material, and an edible liquid and/or plastic ingredient selected from the group consisting of liquid lipid source, plastic lipid source, liquid eggs, or any combination thereof;
grinding at least a portion of the edible food material in the vortex grinding apparatus using a vortex-forming compressed gas, to provide a granular product suitable for preparing baked goods.

2. The process of claim 1, wherein the farinaceous material comprises whole grain.

3. The process of claim 1, wherein the farinaceous material comprises grain flour.

4. The process of claim 1, wherein the dry particulated baking component comprises sweetener, leavening agent, flavorant, and any combination thereof.

5. The process of claim 1, wherein the liquid and/or plastic ingredient comprises vegetable oil.

6. The process of claim 1, wherein the liquid and/or plastic ingredient comprises a plastic fat selected from the group consisting of shortening, butter, margarine, and any combination thereof.

7. The process of claim 1, wherein the liquid and/or plastic ingredient comprises shortening.

8. The process of claim 1, wherein the liquid and/or plastic ingredient comprises liquid egg.

9. The process of claim 1, wherein the liquid and/or plastic ingredient comprises shortening and liquid egg.

10. The process of claim 1, wherein the granular product has an average particle size of less than about 1,000 microns.

11. The process of claim 1, wherein the granular product contains less than about 14 percent total moisture.

12. A process for making a bakery mix comprising:
introducing compressed air into an enclosure that includes a truncated conical shaped section, wherein the introduced air travels along a downward path through the enclosure, including the conical section, to a lower end thereof, and the air reaching the lower end flows back up and exits the enclosure via an exhaust outlet;
introducing, into the enclosure, edible food material comprising a farinaceous material, at least one dry particulated baking component different than the farinaceous material, and an edible liquid and/or plastic ingredient selected from the group consisting of liquid lipid source, plastic lipid source, liquid eggs, or any combination thereof, wherein the edible food material is entrained in the introduced air traveling downward through the enclosure, wherein at least a portion of the edible food material is ground before reaching the lower end of the enclosure;
discharging a granular product including ground edible food material from the lower end of the enclosure, wherein the granular product is suitable as a bakery mix.

13. The process of claim 12, wherein the edible food material comprises about 15 wt. % to about 90 wt. % about whole grain or a flour product thereof, about 1 wt. % to about 45 wt. % sweetener, about 0.25 wt. % to about 35 wt. % shortening, and leavening agent in an effective amount.

14. The process of claim 12, wherein the compressed air comprises supplying compressed air at a pressure within the range of from about 10 psig to about 100 psig.

15. The process of claim 12, wherein the introducing of the compressed air comprises supplying the compressed air at a temperature from about 40° F. to about 600° F.

16. The process of claim 12, wherein the introducing of the compressed air comprises supplying the compressed air at a rate of within the range of from about 500 cubic feet per minute to about 10,000 cubic feet per minute.

17. The process of claim 12, wherein the upper cylindrical enclosure has a substantially constant diameter of about 1 to about 10 feet, and the lower enclosure comprises a truncated conical shape having a maximum diameter size where the lower enclosure adjoins the cylindrical enclosure and the maximum diameter of the lower enclosure is substantially the same as the diameter of the cylindrical enclosure.

18. A bakery mix composition, comprising a granular product which is obtained from introducing compressed air into an enclosure that includes a truncated conical shaped section, wherein the air travels along a downward path through the enclosure, including the conical section, to a lower end thereof, and the air reaching the lower end flows back up and exits the enclosure via an exhaust outlet, and introducing into the enclosure edible food material comprising a farinaceous material, at least one dry particulated baking component different than the farinaceous material, and an edible liquid and/or plastic ingredient selected from the group consisting of liquid lipid source, plastic lipid source, liquid eggs, or any combination thereof, which food material is entrained in the air traveling downward through the enclosure, wherein at least a portion of the food material is ground before reaching the lower end of the enclosure; discharging from the lower end of the enclosure a granular product.

19. The product of claim 18, wherein the edible food material comprises about 15 wt. % to about 90 wt. % whole grain or a flour product thereof, about 1 wt. % to about 45 wt. % sweetener, about 0.25 wt. % to about 35 wt. % shortening, and leavening agent in an effective amount.

20. The product of claim 19, further comprising about 4 wt. % to about 45 wt % liquid egg.
